(19) United States
(12) Patent Application Publication
(10) Pub. No.: US 2025/0383929 A1
(43) Pub. Date: Dec. 18, 2025

(54) SYSTEMS AND METHODS FOR OPTIMIZING USER-FACING SERVICES FOR CLOUD AND EDGE COMPUTING

(71) Applicant: Board of Regents, The University of Texas System, Austin, TX (US)

(72) Inventors: Hong JIANG, Southlake, TX (US); Zhijun WANG, Arlington, TX (US); Hao CHE, Arlington, TX (US); Todd ROSENKRANTZ, Arlington, TX (US); Huiyang LI, Arlington, TX (US); Lin SUN, Arlington, TX (US)

(21) Appl. No.: 19/240,771

(22) Filed: Jun. 17, 2025

Related U.S. Application Data
(60) Provisional application No. 63/660,804, filed on Jun. 17, 2024.

(51) Int. Cl. G06F 9/50; G06F 16/2455

(52) U.S. Cl. CPC G06F 9/5038; G06F 16/2455

(57) ABSTRACT

Systems and methods for processing data queries are provided. In some embodiments, a system comprises a data request component, a query handler component, and a plurality of task servers configured to service the data request. In some embodiments, a request for a data query to be processed is received by the system, a plurality of tasks is generated and a task queuing deadline is determined for the plurality of tasks, and each task is dispatched to a task queue associated with a task server that the task should be dispatched to, where each task is inserted into a respective task queue based on the task queuing deadline.

### CROSS-REFERENCE TO RELATED APPLICATIONS

This application claims the priority benefit of U.S. Provisional Patent Application No. 63/660,804 filed on Jun. 17, 2024, the contents of which are incorporated by reference herein in their entirety.

### STATEMENT REGARDING FEDERALLY SPONSORED RESEARCH

This invention was made with government support under Grant Nos. SHF2226117 and CSR2008835 awarded by the National Science Foundation. The Government has certain rights in the invention.

### FIELD

The technology described herein generally relates to systems and methods for optimizing user-facing services for cloud and edge computing, and more particularly to optimizing user-facing services for cloud and edge computing by maximizing resource utilization and/or query throughput while meeting query tail latency objectives for individual queries.

### BACKGROUND

It has been widely recognized that the query tail latency for Data-intensive User-facing (DU) services, such as web searching, online social networking, and emergency response through edge-based crowdsensing, has a great impact on user experience and hence, business revenues. For example, for Amazon online web services, every 100-millisecond addition of query tail latency causes 1% decrease in sale. To meet strict tail latency Service Level Objectives (SLOs), the resources for DU services are generally over-provisioned (i.e. allocating more resources to a system or application), at the cost of reduced profit. As a result, a key design objective of a DU service, called the design objective, is to maximize the resource utilization or query throughput, while meeting tail latency SLOs for individual queries.

However, achieving this design objective is by no means easy. A query for a typical DU service may spawn a number of tasks, known as query fanout, to be dispatched to, queued and serviced in parallel in different servers or edge nodes where the data shards reside and the slowest task of the query determines the query response time. The range of query fanouts may differ from one service to another, e.g., up to several hundreds for online social networking, on the order of several thousands to tens of thousands for web search, and potentially up to millions for emergency response through edge crowdsening. A small number of outliers (caused by, e.g., skewed workloads or software/hardware resource variations) can significantly impact the query tail latency performance. While a large body of works have been devoted to alleviating the impact of outliers on the query tail latency performance, there is no existing solution that can attempts to meet more than one query tail latency SLO to satisfy different performance requirements of individual users, while maximizing the resource utilization or query throughput, hence falling short of the design objective.

Accordingly, there is a need for improved systems and methods for providing task scheduling based on a request and/or query, that is tail latency SLO aware and also or simultaneously query fanout aware. Embodiments of the technology described herein are directed to these and other considerations.

### SUMMARY

At a high level, aspects of the technology described herein generally relate to task scheduling and/or queuing polity (e.g. a computing task), more particularly to tail latency Service Level Objective (SLO) guaranteed task scheduling and/or queuing policy. In some aspects systems and methods for task scheduling and/or queuing are provided, which in some instances can be implemented for or used in data-intensive user-facing applications (DU). According to some aspects, the technology described herein is directed towards optimizing user-facing services for cloud and edge computing, and maximizing data query throughput utilizing improved task scheduling and processing and resource management.

According to some embodiments, a method for processing a data query is provided. A query handler component can receive a request for a data query to be processed, for example from a user device or front-end server. A plurality of tasks can be generated or spawned based on the data query, and a corresponding task server from a set of task servers can be identified or determined for dispatch. For each task of the plurality of tasks, a task queuing deadline can be determined, which in some instances is the deadline for when the task or tasks may be dequeued, dispatched to a task server, and processed or serviced in order to meet a tail latency SLO for the data query. Each task can be dispatched with the task queuing deadline to a task queue associated with the task server that the task should be dispatched to for processing or servicing.

According to some embodiments, a system is provided and configured to receive, from a user device, a request for a data query to be processed, decompose the data query into a plurality of tasks for completing the data query, each task of the plurality of tasks to be processed by a respective one of a plurality of task servers, estimate a task queuing time budget for processing a respective task based on a typical task sever workload for each task server, transmit instructions for completing a respective task to a respective one of the plurality of task servers for each task of the plurality of tasks, receive, from each task server, a task result comprising a response to the respective task, merging each of the task results to generate a query result responsive to receiving each task result associated with processing the data query, and transmitting the query result to the user device.

In some embodiments, a computer-implemented method for processing a data query is provided comprising receiving, from a user device, a request for a data query to be processed, decomposing the data query into a plurality of tasks for completing the data query, each task of the plurality of tasks to be processed by a respective one of a plurality of task servers, for each task server, estimating a task queuing time budget for processing a respective task based on a typical task sever workload, transmitting instructions for completing a respective task to a respective one of the plurality of task servers for each task of the plurality of tasks, receiving, from each task server, a task result comprising a response to the respective task, responsive to receiving each task result associated with processing the data query, merging each of the task results to generate a query result, and transmitting the query result to the user device.

### BRIEF DESCRIPTION OF THE DRAWINGS

Reference is made to the accompanying drawings and figures, which are not necessarily drawn to scale, which illustrate various implementations, aspects, and principles of the disclosed technology.

FIG. 1 illustrates an example DU application process architecture, in accordance with some aspects of the technology described herein;

FIG. 2 illustrates an example query processing model, in accordance with some aspects of the technology described herein;

FIG. 3a shows a Cumulative Distribution Function (CDF) and the unloaded 95th and 99th percentile task latencies of a Masstree Tailbench workload, in accordance with some aspects of the technology described herein;

FIG. 3b shows a CDF and the unloaded 95th and 99th percentile task latencies of a Shore Tailbench workload, in accordance with some aspects of the technology described herein;

FIG. 3c shows a CDF and the unloaded 95th and 99th percentile task latencies of a Xapian Tailbench workload, in accordance with some aspects of the technology described herein;

FIG. 4a shows the maximum loads with a single service class in the Masstree Tailbench workload, in accordance with some aspects of the technology described herein;

FIG. 4b shows the maximum loads with a single service class in the Shore Tailbench workload, in accordance with some aspects of the technology described herein;

FIG. 4c shows the maximum loads with a single service class in the Xapian Tailbench workload, in accordance with some aspects of the technology described herein;

FIG. 5a shows the maximum loads with two classes for the Masstree workload with respect to a Poisson arrival process, in accordance with some aspects of the technology described herein;

FIG. 5b shows the maximum loads with two classes for the Masstree workload with respect to a Parento arrival process, in accordance with some aspects of the technology described herein;

FIG. 6a shows the 99th percentile latency for a Masstree workload with a first service class with respect to required tail latency and the maximum load that the tail latency can be met, in accordance with some aspects of the technology described herein;

FIG. 6b shows the 99th percentile latency for a Masstree workload with a second service class with respect to required tail latency and the maximum load that the tail latency can be met, in accordance with some aspects of the technology described herein;

FIG. 6c shows the 99th percentile latency for a Shore workload with a first service class with respect to required tail latency and the maximum load that the tail latency can be met, in accordance with some aspects of the technology described herein;

FIG. 6d shows the 99th percentile latency for a Shore workload with a second service class with respect to required tail latency and the maximum load that the tail latency can be met, in accordance with some aspects of the technology described herein;

FIG. 6e shows the 99th percentile latency for a Xapian workload with a first service class with respect to required tail latency and the maximum load that the tail latency can be met, in accordance with some aspects of the technology described herein;

FIG. 6f shows the 99th percentile latency for a Xapian workload with a second service class with respect to required tail latency and the maximum load that the tail latency can be met, in accordance with some aspects of the technology described herein;

FIG. 7a illustrates aspects of query admission control with respect to accepted/rejected loads, in accordance with some aspects of the technology described herein;

FIG. 7b illustrates aspects of query admission control with respect to query tail latencies at different loads, in accordance with some aspects of the technology described herein;

FIG. 8 illustrates an example SaS testbed architecture, in accordance with some aspects of the technology described herein;

FIG. 9a illustrates task post queuing time CDFs in four clusters and the 95th and 99th percentile tail latencies, in accordance with some aspects of the technology described herein;

FIG. 9b illustrates the 99th percentile query tail latency of a class at various loads, in accordance with some aspects of the technology described herein;

FIG. 9c illustrates the 99th percentile query tail latency of a class at various loads, in accordance with some aspects of the technology described herein; and

FIG. 9d illustrates the 99th percentile query tail latency of a class at various loads, in accordance with some aspects of the technology described herein.

### DETAILED DESCRIPTION

Embodiments described herein can be understood more readily by reference to the following detailed description and examples. The systems and methods described herein, however, are not limited to the specific embodiments presented in the detailed description and examples. It should be recognized that these embodiments are merely illustrative of the principles of the disclosed technology. Numerous modifications and adaptations will be readily apparent to those of skill in the art without departing from the scope of the disclosure. Accordingly, this disclosure is not intended to embrace all such alternatives, modifications and variations that fall within the scope of the disclosure.

In addition, all ranges disclosed herein are to be understood to encompass any and all subranges subsumed therein. For example, a stated range of “1.0 to 10.0” should be considered to include any and all subranges beginning with a minimum value of 1.0 or more and ending with a maximum value of 10.0 or less, e.g., 1.0 to 5.3, or 4.7 to 10.0, or 3.6 to 7.9.

All ranges disclosed herein are also to be considered to include the end points of the range, unless expressly stated otherwise. For example, a range of “between 5 and 10” or “5 to 10” or “5-10” should generally be considered to include the end points 5 and 10.

Further, when the phrase “up to” is used in connection with an amount or quantity; it is to be understood that the amount is at least a detectable amount or quantity. For example, a material present in an amount “up to” a specified amount can be present from a detectable amount and up to and including the specified amount.

Additionally, in any disclosed embodiment, the terms “substantially,” “approximately,” and “about” may be substituted with “within [a percentage] of” what is specified, where the percentage includes 0.1, 1, 5, and 10 percent.

It is also to be understood that the article “a” or “an” refers to “at least one,” unless the context of a particular use requires otherwise.

In one aspect, a system for processing a data query is described herein. In another aspect, a computer-implemented method of processing a data query is described herein. At a high level, the disclosed systems and methods relate to optimizing data-intensive user-facing (“DU”) services for cloud and edge computing. In this regard, the disclosed systems and methods are designed to maximize query throughput while simultaneously minimizing tail latency for each query.

In some embodiments, the system can include one or more processor and a non-transitory memory in communication with the one or more processors and storing instructions thereon, that when executed by the processors are configured to cause the system to perform a method of processing a data query. The system may receive, from a user device, a request for a data query to be processed. In response, the system may decompose the data query into a plurality of tasks for completing the data query. It should be understood that, according to at least some embodiments, each task of the plurality of tasks is to be processed a respective downstream task server, wherein each task server operates to process each task in a parallel fashion. The system may estimate, based on a typical task server workload, a task queuing time budget for processing a task assigned to a respective task server. In turn, each task server may be configured to process tasks as tasks are assigned. The task server may determine a task result based on the assigned task and may transmit the task result to the system as the task result is determined. The system may receive, from each task server, a task result that comprises a response to the respective task assigned to the given task server. In response to receiving each task result associated with processing a data query, the system may merge each of the task results to generate a query result, and transmit the query result to the requesting user device.

In another aspect, a method for processing a data query is described herein. The method may include receiving, from a user device, a request for a data query to be processed. The data query may be decomposed into a plurality of tasks for completing the data query. Each of the plurality of tasks may be processed by a respective one of a plurality of task servers. A task queuing time budget for processing a respective task may be estimated for each task server, based on a typical server workload. Instructions for completing a respective task to respective one of the plurality of the plurality of task servers may be transmitted for each task of the plurality of tasks to be processed. The method may include receiving, from each task server, a task result comprising a response to the respective task. In response to receiving each task result associated with processing the data query, the method may include merging each of the task results to generate a query result. The query result may be transmitted to the user device.

A query is understood to be “processed” once the system receives every task result associated with the plurality of tasks, merges the task results to generate a query result, and transmits the query result to the requesting user device. Because tasks are processed in parallel by the task servers, it should also be understood, that according to at least some embodiments, the total time for processing a respective task is equivalent to the time it takes for the slowest task result to be processed. Accordingly, embodiments of the systems and methods described herein are configured to optimize query throughput by taking into account “query fanout,” which as used herein is understood to mean the measure of how many parallel task servers are required to process tasks to complete a given data query. For example a query fanout of 1 indicates that the tasks associated with a given query are processed by only a single task server. A query fanout of 100 indicates that the tasks associated with a given query are assigned to and processed by 100 task servers operating in a parallel fashion. In this regard, the disclosed systems and methods are also configured to prioritize queries associated with a greater query fanout, because queries with a greater query fanout are more likely to suffer from higher latency due to the likelihood that at least one task server experiences a higher latency while determining and transmitting a given task result back to the system to be merged into a query result.

As used herein a “query” means a request for data from one or more databases or servers. As used herein, a “task” describes a logical sub-part of a data query that is a request for a portion of the data required to process a respective query. As used herein a “task latency” means the time delay between transmitting instructions for the task to be processed to a task server, and receiving the associated task result from the task server. As used herein, a “task latency threshold” means a predetermined time threshold for receiving a task result from a task server pursuant to transmitting instructions to the given task server to process a given task. As used herein, the term “tail latency” means the time delay between receiving instructions to process a given data query from an end-user and when the system computes and transmits the resultant query result to the end-user. The term “tail latency requirement” means a target response time for processing a data query and transmitting the result to the end-user. For example, a tail latency requirement can be expressed as a percentage of queries meeting a predetermined tail latency threshold. In this regard, an end-user can provide a tail latency threshold requirement to the system, while in other embodiments, the tail latency requirement can be predetermined by the disclosed system. In one example, an end-user may set the tail latency requirement to be a 99th percentile query tail latency to be 500 ms. In this example, the query tail latency requirement is that at least 99% of the queries received by the system are “processed” in no longer than 500 ms. As used herein “a query queuing budget measure” means a time estimate that the system determines for the tail latency of a given query. As will be further understood, at a high level, a tail latency Service Level Objective (SLO) can be understood as specifying the acceptable latency for the slowest requests or queries, and can be expressed in some instances as a high percentile, for instance the 99th percentile, such as 99% of requests should complete in under 1 second, under 500 ms, or under 100 ms.

According to some embodiments, the disclosed systems and methods can include intermittently updating the task queuing time budget for subsequent tasks to be processed based on a queuing time of a task previously processed by the respective task server. In this regard, the disclosed system and methods are capable of updating the task queuing time budget based on an amount of time it takes a given task server to process an task assigned to the given task server.

In some embodiments, the disclosed systems and methods can include receiving more than one data query simultaneously (e.g., a first query and a second query, a first data query and a second data query). In some embodiments, the disclosed systems and methods can include determining a query fanout indicator or measure for the first data query and the second data query based on a number of task servers required to process each task associated with the first data query and the second data query, respectively, and determining which of the first query and the second query to process first based on the determined query fanout measures.

In some embodiments, the disclosed systems and methods can include assigning a task latency threshold to the request and, responsive to a threshold number of tasks of the plurality of tasks exceeding the task latency threshold, rejecting the queuing of subsequent data queries until the task latency threshold is no longer exceeded.

In some embodiments, the user device can comprise a server, for example a front-end server.

Aspects of the technology described herein generally relate to task scheduling and/or queuing (e.g. a scheduling and/or queuing one or more computing tasks), resource management (e.g. computing resources), and more particularly to tail latency Service Level Objective (SLO) guaranteed task scheduling and/or queuing, for instance based on a received request or quer In some aspects systems and methods for task scheduling and/or queuing are provided, which in some instances can be implemented for or used in data-intensive user-facing applications.

As will be appreciated, in some instances, as will be understood with respect to computing environments or architectures, and related systems and methods, a task can be understood as a unit of work or execution, that can, for instance, be a single step, a process, a thread, etc. depending on a given context. In some aspects, a task, or set of tasks, can be understood as what a computer, computing environment, computing system etc. is actively doing at a given moment. In some examples, as a unit of work, a task can represent a specific action(s) or operation(s), or set of instructions that need to be or may be performed by a system. In some examples, as a unit of execution, a task can also refer to a process or thread which represent how a system carries out a program or set of instructions. In some examples, a task or set of tasks can be a part of a larger unit of work, for example a job where several tasks or set of tasks are combined, for instance to achieve a specific goal.

As will be appreciated, one primary design objective for Data-intensive User-facing (DU) services for cloud and edge computing systems, methods, and architectures, is to maximize query throughput while also meeting query tail latency Service Level Objectives (SLOs) for individual queries. Unfortunately, existing computing systems, architectures, and solutions fall short of achieving such a design objective which can in some aspects be largely attributed to the fact that they do not take the query fanout into account. As such, according to systems and methods provided herein an improvement in computer technology is achieved through the implemented query processing system, model, and/or method which incorporates task decomposition that includes task queuing that is tail latency SLO aware and fanout aware, and in some aspects incorporates query admission control. Further, embodiments of the technology realize improved computing resource management based on the query level and task level processing techniques, and further improved computing methods and systems are realized through the technology described herein which in some instances provide for optimizing user-facing services for cloud and edge computing by maximizing resource utilization (e.g. computing resources) and/or query throughput while meeting query tail latency objectives for individual queries, for instance used in such user-facing services. In some further aspects, systems and methods provided by the technology described herein are improved data request or query systems, which are more efficient that conventional systems, require less processing usage, and can adapt based on various input or query arrival parameters.

As will be appreciated, improvements in computing systems, or the technological solution provided by the technology described herein, are realized through the implementation of data query or request decomposition and task scheduling that is both tail latency SLO aware and query fanout aware. As will be appreciated, to meet a given tail latency SLO, the task resource demands for tasks (e.g. data retrieval from a server) belonging to queries with different fanouts are different. For example, to meet a query tail latency SLO for all queries regardless of query fanouts, the task resource demands for tasks belonging to queries with different fanouts are different, and a task belonging to a query with a larger fanout demands more resources. According to some aspects, with a given tail latency SLO, tasks belonging to queries with different fanouts can be treated differently, e.g. by being allocated different amounts of resource to more closely match their resource demands so that all the queries can meet the given tail latency SLO at the lowest possible resource consumption. In some aspects, a query or request system is provided. In some aspects, a tasks scheduling and/or resource management system is provided. In some aspects, a dynamic task scheduling system and/or method is provided that is a tail-latency-SLO-and-fanout-aware earliest-deadline-first-queuing (TF-EDQF) policy, reflecting in some aspects a set operations.

According to some aspects, at a query level, a task decomposition is utilized or implemented to translate the query tail latency SLO for a query with a given fanout into a task queuing deadline for tasks spawned or generated by the query at the task level. In some aspects, this reflects the resource demand(s) of the tasks. In some aspects, this can effectively decompose a hard cotask scheduling problem at the query level into individual queue management subproblems at the task level. At the task level, in some aspects, a single TD-EDFQ corresponding to a task server (in some cases of a plurality of tasks servers) is used to enforce the task queuing deadlines, for instance as a way to differentiate resource allocation for tasks with different resource demands. In some instances, embodiments of the present technology permit unlimited number of query classes and is lightweight as it incurs minimum overhead for tasks queuing deadline estimation and may be implemented with a single EDFQ per task server for any DU application.

Data-Intensive User-Facing (DU) Services. DU services are a predominant class of workloads in today's cloud and have also emerged as an important class of workloads in an edge-cloud ecosystem, generally known as SaS, among others. Predominant DU services are driven by queries that may require query responsiveness in sub-seconds to seconds and may need to touch on massive datasets, which are typically carried out in a data parallel fashion. The working dataset for a service (e.g., the total amount of crowdsensing data in the case of an SaS) in this class are distributed to a large number of task servers/edge nodes. Accordingly, a query may spawn a number of tasks to be dispatched to some or all of these task servers/edge nodes to be processed. A notable subclass of such services is OnLine Data-intensive (OLDI) services. A query for an OLDI service needs to touch upon every part of the working dataset, i.e., the query fanout for each query is equal to the total number of servers involved (ranging from a few to tens of thousands). Large online search products, online advertising and online machine translation, are examples of OLDI services. For other DU services, different queries may need to touch upon different parts of the working dataset. A notable example of such a service is social networking services, such as Facebook and LinkedIn. For instance, the fanout for a typical Facebook page query is in the range of one to several hundred with 65% under 20. Other examples are emergency response SaSes, e.g., finding a missing person through surveillance cameras and fire detection and alert via crowd temperature sensing. A query of such a service is expected to have a fanout anywhere between one to a few millions depending on the scope of sensing.

A DU service may be launched in a dedicated datacenter cluster owned by a service provider, e.g., the web search service by Google, in a cloud by a tenant who rents cloud resources from a cloud service provider (e.g., Amazon cloud), or in an edge-cloud ecosystem owned by multiple stakeholders, including individuals who own the sensing data and/or edge devices and cloud service providers.

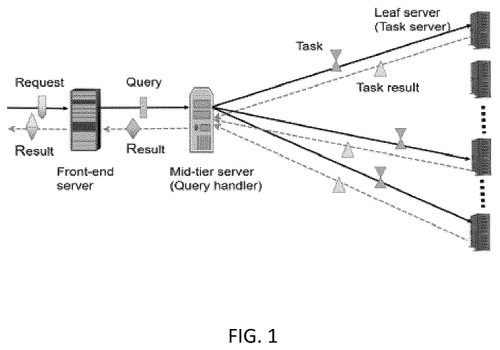

FIG. 1, illustrates an example DU processing model. As shown, the processing model can be composed of three-parts, including a front-end server, a mid-tier server (also referred to as a query handler), and a set (e.g. one or more) of back-end leaf servers (also referred to as task servers), with each hosting a piece of the total dataset, also referred to as a shard, a partition, or a published sensing dataset (e.g. in an edge node).

When a user request arrives at the front-end server, its workflow is parsed to generate a set of queries to be issued sequentially to the query handler at the mid-tier server. Due to query/task dependency, the next query cannot be issued until the current one finishes. For each query received, the query handler spawns a number of tasks for the query and dispatches them to the queues corresponding to the task servers that will serve them when they reach the queue heads. The tasks for the same task server are queued based on a given queuing mechanism. In practice, task servers are usually allocated dedicated CPU/memory/storage resources in the form of, e.g., cores, VMs, containers, or pods, as well as fix-sized data shards, forming a more or less homogeneous task server cluster. As a result, the differentiation of resource allocation among tasks with different resource demands are mainly through task queuing policies, e.g. PRIQ, task-reordering-based queueing, or EDFQ unless task-aware resource auto-scaling is allowed.

Upon completion of the execution of a task, the task result is returned to the query handler to be merged with the task results from the other tasks of the query. The query finishes when all the task results are merged and sent to the frontend server. Hence the task response time for the slowest task dictates the query response time. In turn, the request completes when the last query in the request finishes.

Tail Latency Aware Solutions for DU Services. Previous works have been have been devoted to addressing query tail latency related issues for DU services, which can be broadly classified into two categories, i.e., outlier alleviation, focusing on curtailing the tail length of the task response time to improve overall query tail latency performance, and tail latency SLO guarantee for queries sharing a single tail latency SLO. The below elaborates more on the solutions in the two categories, respectively.

Outlier Alleviation. Most existing solutions fall into this category. Some typical examples in this category are listed as follows. Solutions based on task-size-aware task reordering in a task queue are proposed to avoid head-of-line blocking of small-sized tasks by large-sized ones to reduce the mean task latency. Task-aware scheduling schemes are designed to shorten the tail latency for tail latency critical tasks in workloads with both batch and tail latency critical queries. Redundant-task-issue solutions are developed to reduce the task tail latency by allowing a task to be issued to multiple task server replicas. Task execution time prediction through workload profiling and machine learning are widely employed to adjust the level of parallelism to remove task bottlenecks or to avoid sending tasks with predicted long execution time to poorly performing task severs to reduce task tail latency. Solutions based on synchronized garbage collection for all task servers are proposed to minimize variabilities of task execution times among parallel tasks to reduce query tail latency. Solutions that allow partial results to be returned to fulfill a query can maintain more predictable query tail latency at the cost of possible loss of partial results. Dynamic resource allocation based on the feedback loop control mechanisms are proposed to help reduce query tail latencies. CPU power control schemes are developed to dynamically adjust voltage and frequency scaling (DVFS) for task servers based on task execution time to save energy and maintain low task tail latency. A query fanout control scheme is designed to control the fanout in queries to optimize the system performance. A transaction scheduling solution for geo-distributed databases uses transaction timestamps to reduce both mean and tail latencies for edge computing. All these solutions can help reduce the query tail latency, but cannot provide or enable SLO guarantee.

Tail Latency SLO guarantee. There are a few existing solutions in this category, including Cake, PriorityMeister, SNC-Meister, WorkloadCompactor, and PLSO, all for shared datacenter storage applications. All these solutions, except Cake, aim at meeting a single query tail latency SLO for all queries with fanout of one only. Cake can handle fanout of more than one, but is unable to enable per-class or per-query tail latency SLOs, as it relies on direct measurement of the overall tail latency statistics as input for control, resulting in fanout-unaware resource overprovisioning. Clearly, a solution based on direct tail latency statistics measurement like Cake cannot be extended to allow per-query resource allocation, simply because the needed statistics are unavailable at this granularity. Some tail latency SLO guaranteed solutions for micro-service such as GrandSLAm, and Sinan have been proposed. But again they cannot support per-query tail latency SLO.

The deficiencies of conventional or previous systems, and the shortcomings associated therewith and described herein are overcome by embodiments of the present technology, which provides various application features, for instance provide improved performance of request/query system, for example a data-intensive query system that is serviced by a number of task servers, where the improved performance utilizes improved task scheduling and resource management (e.g. computing resources) such that task scheduling is configured to meet a given tail latency SLO but also taking into account the task resource demands for tasks belonging to queries with different fanouts.

In some aspects, embodiments of the technology described herein are directed towards a dynamic task scheduling system and method (sometimes referred to herein as Tailguard) which can be implemented for data-intensive user-facing applications, and enabling maximizing resource utilization, while simultaneously or also providing tail latency SLO guarantee. The dynamic task scheduling system and method decouples the upper query level design from the lower task level design. At the query level, a decomposition technique is provided to compute the task queuing deadline for a query with a given tail latency SLO and fanout. At the task level, based on the determined task queuing deadline, an queuing policy is employed (e.g. earliest-deadline-first queuing policy) to manage task queues and improve computing resource utilization. As will be appreciated, according to the technology described herein, the dynamic task scheduling system and method provide an improvement in computing technology, which are demonstrated in the testing described below, through a shown improvement in resource utilization by up to 80% while meeting tail latency SLOs as compared to conventional or known queuing policies.

Aspects of a dynamic task scheduling system are further described herein with respect to various components, for example a query processing model or schema, a task decomposition component (or alternatively a task queuing deadline estimation component), and query admission control scheme, among others. Systems and methods for task scheduling and/or queuing, for example based on a request or query input or supplied. As will be appreciated, tail latency generally refers to the latency of requests or packets that take a longer time to process, typically the slower portion of a distribution. In some aspects, tail latency becomes crucial in AI, networking, and data centers because it highlights bottlenecks that can impact overall performance of a system

As will be appreciated, reference is made to the follow defined terms listed in Table 1, with respect to various aspects of the dynamic task scheduling system.

| Symbol | Description |
|---|---|
| N | Number of task servers |
| M | Number of queries in a request |
| k_{f} | Fanout of a query |
| T_{b} | Task pre-dequeuing time budget for a query |
| t₀ | Query arrival time |
| t_{D} | Task queueing deadline (t_{D} = t₀ + T_{b}) |
| tₚᵣ | Task pre-dequeuing time |
| tₚₒ | Task post-queuing time or unload task response time |
| tᵣ | Task response time (tᵣ = tₚᵣ + tₚₒ) |
| ${x}_{p}^{SLO}$ | pth percentile query tail latency SLO |
| ${x}_{p}^{u} ( {k}_{f} ) / {x}_{p} ( {k}_{f} )$ | Unloaded/loaded pth percentile tail latency for a query with fanout k_{f} |
| ${F}_{l}^{u} ( t ) / {F}_{l} ( t )$ | CDF of unloaded/loaded task response time with respect to task server l |
| ${F}_{Q}^{u} ( t ) / {F}_{Q} ( t )$ | CDF of unloaded/loaded response time for a query |
| P(k_{f}) | Probability of a query with fanout k_{f} |

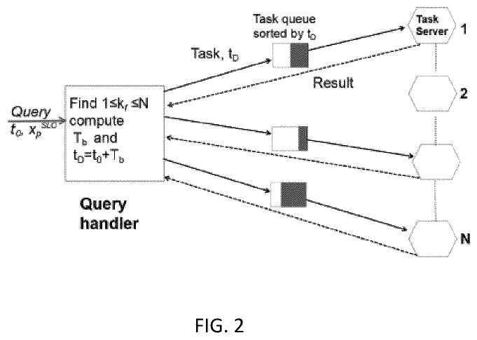

Query Processing Model. A query processing model is derived or generated from the model shown in FIG. 1 and is depicted in FIG. 2. The query processing model is composed of a query arrival process, a query handler, and N task servers. In some aspects, the query arrival process characterizes the randomness of queries arriving at the query handler. As illustrated in FIG. 2, a task queue for a task server can be set in the task server or in the query handler.

At the query level, upon receiving a query at time, t₀, the query handler first determines how many tasks (i.e., the query fanout, k_{f}) should be spawned and to which k_{f} task servers these tasks should to be dispatched. The query handler estimates task pre-dequeuing time budget T_{b} and computes the task queuing deadline t_{D}=t₀+T_{b}, shared by all the tasks associated with the query. Here t_{D} is defined as the deadline when the task may be dequeued and given to the corresponding task server to be processed in order to meet the tail latency SLO for the query. As is further described below, T_{b} (or t_{D}) is a function of both query tail latency SLO in terms of the pth percentile query latency of

$${x}_{p}^{SLO}$$

and query fanout, k_{f}, i.e.,

$${T}_{b} = {T}_{b} ( {x}_{p}^{SLO} , {k}_{f} ) and {t}_{D} = {t}_{D} ( {x}_{p}^{SLO} , kf ) .$$

Finally, the tasks, together with their deadlines, are dispatched to the queues corresponding to the task servers. Since task pre-dequeuing time budget, T_{b}, is an explicit function of both

$${x}_{p}^{SLO}$$

and k_{f} for the query, aspects of the dynamic tasks scheduling systems and methods permit per-query tail latency SLOs. At the task level, each task queue adopts a TF-EDFQ, based on

$${t}_{D} ( {x}_{p}^{SLO} , {k}_{f} ) .$$

When a task is to be enqueued at a task queue, if the corresponding task server is idle, the task is serviced immediately, otherwise, it is inserted into the task queue with tasks ordered in increasing order of t_{D}'s, hence with the task of the smallest t_{D} at the head of the queue. Whenever a task in service finishes, the task at the head of the queue is put in service immediately. Finally, upon the completion of execution of a task, the task result is sent back to the query handler to be merged. A query finishes as soon as the merging of all the task results completes.

The dynamic task scheduling system ensures that tasks with a higher chance to cause the violation of the associated query tail latency SLO will be serviced earlier, and therefor aspects of the present technology enable improved system utilization.

As previously noted, the performance of the dynamic task scheduling system improves upon known systems and methods, and are compared hereinbelow against FIFO, PRIQ, and T-EDFQ. In terms of queueing policy, FIFO is a first-in-first-out queuing policy. PRIQ assigns tasks of different classes to different queues with strict priorities given to the queue of a higher class over that of a lower class. T-EDFQ works in some similar ways to the present dynamic task scheduling system except that

$${t}_{D} = {t}_{0} + {x}_{p}^{SLO} .$$

In other words, the queueing deadline for a task is dependent on the corresponding query tail latency SLO,

$${x}_{p}^{SLO} ,$$

but independent of query fanout k_{f}. As can be seen, both PRIQ and T-EDFQ degenerate to FIFO if all queries have the same tail latency SLO, i.e., the case with a single class.

Task queueing deadline estimation. One design feature of the dynamic task scheduling system is the task queuing deadline estimation or task decomposition, which can be implemented in the system and utilized in methods provided by the system.

The task queuing deadline estimation problem can be formally stated as follows: for a query with fanout, k_{f}, a given tail latency SLO in term of

$${x}_{p}^{SLO} ,$$

and arrival time, t₀, find the task queuing deadline,

$${t}_{D} = {t}_{0} + {T}_{b} ( {x}_{p}^{SLO} , {k}_{f} ) ,$$

for tasks spawned by the query. Here

$${T}_{b} ( {x}_{p}^{SLO} , {k}_{f} ) ,$$

the task pre-dequeuing time budget, is the maximum allowable task pre-dequeuing time before the task may be dequeued and given/sent to the task server to be processed, in order to meet the query tail latency SLO.

First it is noted that the task response time (also called loaded task response time), tᵣ, can be generally expressed as, tᵣ=tₚᵣ+tₚₒ, where tₚᵣ represents the task pre-dequeuing time and tₚₒ stands for task post-queuing time or unloaded task response time. tₚᵣ is composed of task scheduling time and task queuing time, if task queuing takes place centrally at the query handler. It also includes task dispatching time, if task queuing occurs at the task server. tₚₒ includes all the times the task incurs after de-queuing.

Now it can be assumed that the Cumulative Distribution Function (CDF) of the unloaded task response time tₚₒ,

$${F}_{l}^{u} ( t ) ,$$

with respect to task server, I, can be measured and updated for all task servers l=1, . . . , N. Furthermore, let

$${x}_{p}^{u} ( {k}_{f} ) and {F}_{Q}^{u} ( t , {k}_{f} )$$

represent the pth percentile unloaded query tail latency for a query with fanout kf and the CDF of unloaded query latency, respectively. Here, a query latency is considered as unloaded (loaded) if the query response time does not (does) include pre-dequeuing delay, tₚᵣ. Also define n=n(k) to be the mapping between the k-th task in a query and the n-th task server the task is dispatched to, for k=1, . . . , k_{f}. Clearly, the unloaded query latency is the task post-queuing time of the slowest of all k_{f} tasks. According to ordered statistics:

$${F}_{Q}^{u} ( t , {k}_{f} ) = {\prod }_{k = 1}^{{k}_{f}} {F}_{n ( k )}^{u} ( t ) . \qquad ( 1 )$$

By definition, then:

$${x}_{p}^{u} ( {k}_{f} ) = {F}_{Q}^{u - 1} ( \frac{p}{100} ) , \qquad ( 2 )$$

Where

$${F}_{Q}^{u - 1} ( \cdot )$$

is the inverse function of

$${F}_{Q}^{u} ( \cdot ) .$$

Assuming that all the tasks in a query experience the same pre-dequeuing delay tₚᵣ, the CDF of the response time for task l, Fₗ(t) can be expressed as follows:

$${F}_{l} ( t ) = \{ \begin{matrix}{F}_{l}^{u} ( t - {t}_{pr} ) , & if t \geq {t}_{pr} \\ 0 , & otherwise\end{matrix} . \qquad ( 3 )$$

Hence

$${F}_{Q} ( t , {k}_{j} ) = {\sum }_{k = 1}^{{k}_{f}} {F}_{n ( k )} ( t ) = \{ \begin{matrix}{F}_{Q}^{u} ( t - {t}_{pr} , {k}_{f} ) , & if i \geq {t}_{pr} \\ 0 , & otherwise ,\end{matrix} \qquad ( 4 )$$

$$and$$

$${x}_{p} ( {k}_{f} ) - {t}_{pr} = {F}_{Q}^{u - 1} ( \frac{p}{100} ) .$$

From Eqns. (2) and (4), then

$${x}_{p} ( {k}_{f} ) = {x}_{p}^{u} ( {k}_{f} ) + {t}_{pr} . \qquad ( 5 )$$

This result means that with any given query tail latency SLO,

$${x}_{p}^{SLO} ,$$

as long as

$${t}_{pr} \leq {x}_{p}^{SLO} - {x}_{p}^{u} ( {k}_{f} ) ,$$

the query tail latency SLO is guaranteed to be met, i.e.,

$${x}_{p} ( {k}_{f} ) = {x}_{p}^{u} ( {k}_{f} ) + {t}_{pr} \leq {x}_{p}^{SLO} .$$

This means that the task pre-dequeuing time budget

$${T}_{b} ( {x}_{p}^{SLO} , {k}_{f} )$$

can be defined as

$${T}_{b} ( {x}_{p}^{SLO} , {k}_{f} ) = {x}_{p}^{SLO} - {x}_{p}^{u} ( {k}_{f} ) ,$$

or equivalently the task queuing deadline can be defined as,

$${t}_{D} = {t}_{0} + {T}_{b} ( {x}_{p}^{SLO} , {k}_{f} ) = {t}_{0} + {x}_{p}^{SLO} - {x}_{p}^{u} ( {k}_{f} ) . \qquad ( 6 )$$

In other words, for a query arrived at t=t₀, as shown in FIG. 2, so long as all the tasks belonging to this query are dequeued no later than t_{D}, the query tail latency SLO,

$${x}_{p}^{SLO} ,$$

is guaranteed to be met.

Ideally, under the work conserving condition (i.e. the condition whereby the task server is always busy as long as there are unfinished tasks at the server), if a queuing policy can ensure that all the tasks exactly meet their queuing deadlines, the design objective is achieved. In practice, however, such a queuing policy may not exist. As a first step, the dynamic task scheduling system adopts EDFQ based on t_{D}, i.e., TF-EDFQ, to enforce the task queuing deadlines. This queuing policy can ensure that the task with the earliest queuing deadline is placed at the head of the queue before deadline. However, it cannot guarantee that the task at the head of the queue can always be served before deadline, simply because the task ahead of it may be still in service when the deadline is reached. On the other hand, the task may also have a chance to be dequeued before deadline, if the task server becomes idle before deadline. This implies that the system may tolerate a small percentage of tasks missing their deadlines without violating the tail latency SLOs as the tail latency is a probabilistic measure.

In some instances, the task decomposition technique for queries can be extended to a task decomposition technique for requests that account for query dependencies. Consider a request composed of M queries to be issued sequentially and with the request tail latency SLO expressed in terms of the pth percentile of request latency of,

$${x}_{p}^{R , SLO} .$$

Now, the request response time

$${t}_{r}^{R} = {\sum }_{i = 1}^{M} {t}_{r , i} ,$$

where t_{r,i} is the query response time for the i-th query. Although this relationship is an additive one, the one for the corresponding tail latency is not. As the CDF of the request response time, F_{R}(t), is the convolutions of all the CDFs of the constituent query response times, in general,

$${x}_{p}^{R , SLO} < {\sum }_{i = 1}^{M} {x}_{p , i}^{SLO} ,$$

making query decomposition for requests difficult. In what follows, it is shown that the above task decomposition technique can be generalized to establish an additive relationship between the request pre-dequeuing time budget and task pre-dequeuing time budgets for the constituent queries, paving the way for the development of a task decomposition technique for requests.

Define unloaded request latency,

$${t}_{po}^{R} = {\sum }_{i = 1}^{M} {t}_{po , i}$$

and the CDF of the unloaded request response time,

$${F}_{R}^{u} ( t )$$

### to be the CDF of

$${t}_{po}^{R} ,$$

where t_{po,i} is the unloaded query latency for the i-th query. Further assume that all the tasks of query i have the same pre-dequeuing time t_{pr,i}, and define request pre-dequeuing time

$${t}_{p r}^{R} = {\sum }_{i = 1}^{M} {t}_{pr , i} .$$

Then the loaded request response time is

$${t}_{r}^{R} = {\sum }_{i = 1}^{M} ( {t}_{p o , i} + {t}_{pr , i} ) = {t}_{po}^{R} + {t}_{p r}^{R} .$$

Clearly, by substituting tᵣ, tₚᵣ, tₚₒ, F_{Q}, and

$${F}_{Q}^{u}$$

with

$${t}_{r}^{R} , {t}_{p r}^{R} , {t}_{p o}^{R} , {F}_{R} , and {F}_{R}^{u} ,$$

and following Eqns. (4) and (5), then

$${x}_{p}^{R} = {x}_{p}^{{R}^{u}} + {t}_{pr}^{R} = {x}_{p}^{{R}^{u}} + {\sum }_{i = 1}^{M} {t}_{pr} , i , \qquad ( 7 )$$

where

$${x}_{p}^{R} and {x}_{p}^{{R}^{u}}$$

are the loaded and unloaded pth percentile tail latency of the request. Eqn. (7) means that the request pre-dequeuing time budget

$${T}_{b}^{R} = {x}_{p}^{R , SLO} - {x}_{p}^{{R}^{u}} ,$$

and it is additive, i.e.,

$${T}_{b}^{R} = {\sum }_{i = 1}^{M} {T}_{b , i} ,$$

here T_{b,i} is the task pre-dequeuing budget for query i, for i=1, . . . , M.

Note that as long as

$${T}_{b}^{R} ( i . e . , {t}_{pr}^{R} \leq {T}_{b}^{R} )$$

is met, the request tail latency SLO will be met regardless the assignments of T_{b,i}'s. However, different assignments may lead to different resource utilizations. Hence, in some aspects with a given total budget

$${T}_{b}^{R} ,$$

budgets T_{b,i} can be assigned to individual queries so that resource utilization is maximized.

Implementation. The above task queuing deadline estimation solution requires the availability of the task post-queuing time distributions, Fₗ(t), for all the task servers, which may be conveyed to the query handler for task predequeuing time budget estimation. Accordingly, in some aspects an implementation approach to estimate Fₗ(t)'s by means of a combined initial offline estimation process and a periodical online updating process is provided.

Offline estimation process. As mentioned earlier, DU services are likely to run in a more or less homogeneous cluster. So before the service starts, we set Fₗ(t)≈F (t), for l=1, . . . . N. This lends us a handy way to perform an initial offline estimation of a single distribution function F (t), which serves as the initial distribution for all the task servers. More specifically, use a query handler and single task server and load it with a typical task workload trace to collect a sufficient number of samples of task post-queuing times offline. Then use these samples to construct F (t) to be used as the initial distribution function for all task servers. This allows task queuing deadlines to be estimated at the very start of a DU service.

Online updating process. To account for the inevitable heterogeneity in practice (e.g., due to skewed workloads, uneven resource allocation and resource availability changes), Fₗ(t)'s may be periodically updated online. Fortunately, this can be done with low cost. When the query handler receives and merges the task result for a task from task server l, it uses the current time minus the task dequeue time (which is either locally available if the queuing takes place in the query handler, or comes with the task result from the task server l) as the post-queuing time for the task to update Fₗ(t). This updating process accounts for all the possible post-queuing delays incurred by the tasks, including the long delays caused by outliers. Hence the system can capture heterogeneity through online updating process.

Implementation complexity. The computation complexities for both task queuing deadline estimation and queuing management in the system and/or method and/or policy are low. The former entails the evaluation of two equations, i.e., Eq. (2) for

$${x}_{p}^{u} ( {k}_{f} ) ,$$

which can be done in the background for all possible k_{f}'s in advance and updated when Fₗ(t)'s change and Eq. (6) for each query. The latter requires the management of a single EDFQ. As a result, the present technology is a lightweight solution.

Query admission control. The dynamic task scheduling system and/or method can provide tail latency SLO guarantee for all queries, when there are enough resources to sustain the workload. In the presence of resource shortages due to, e.g., sudden surges of workloads or hardware/software failures, some upcoming queries may need to be rejected to ensure that all admitted queries can meet the prepaid tail latency SLOs. Query admission control is particularly desirable in the case where resource auto-scaling cannot be done, e.g., due to monetary budget or resource constraints (e.g., edge resources may be quite limited to allow an SaS to scale).

The dynamic task scheduling system and/or method was tested using various workloads and found that the query tail latency SLOs can still be met, when a small portion (less than 2% in testing) of tasks miss their deadlines, confirming the aforementioned observation. With this understanding, the dynamic task scheduling system sets a threshold for the percentage of tasks missing their deadlines, Rth, for query admission control. If the task queuing takes place centrally at the query handler, the information on whether a task misses its deadline or not is immediately available to the query handler, otherwise, this information can be piggybacked on the task results returned from the task sever. The query handler can update the task deadline violation ratio in a given moving time window. When the ratio exceeds Rth, upcoming queries are rejected, till the ratio falls back below Rth again. The moving time window can be set to be the same as the time window in which the tail latency SLOs should be guaranteed.

Performance evaluation. To cover a wide range of applications, the dynamic task scheduling system is firstly evaluated on simulation using the workload statistics for three datacenter applications available in Tailbench as input. We the workload is characterized and then the simulation results are presented along the fanout and service class dimensions; and then with query admission control. Finally the dynamic task scheduling system is verified in a highly heterogeneous SaS testbed.

Workloads. For simulation, a DU workload may be characterized by a query arrival process, a query fanout distribution and a task post-queuing time distribution. Unfortunately, the available real traces simply do not contain the needed information. Although traces for commercial DU services in cloud are available, e.g., those made available by Google and Alibaba, they only include the CPU and memory usage information for task servers, not the information needed to drive the simulation at the task level, including the arrival process, query fanouts and task service times. Hence, we resort to modeling for the first two and benchmarks for the third one, as described in detail below.

First, since the Poisson process has been widely recognized as a good model for cloud applications in general, by default, it is assumed that the query arrival process is Poisson with mean arrival rate, λ, a tunning knob to adjust the system load. Meanwhile, to test the performance sensitivity of the dynamic task scheduling system with respect to the burstiness of query arrivals, a burstier arrival process, i.e., the Pareto arrival process, is also used in one simulation case.

Second, although a few publications do offer fanout distribution, P(k_{f}), for k_{f}=1, . . . , N, for the DU services, e.g., the Facebook social networking service, they do not provide task service times needed for the task-level simulation. This, however, should not be too much of a concern, as the dynamic task scheduling system needs to be applicable to both the existing and future workloads whose P(k_{f})'s are not known yet. Hence, quite different P(k_{f}) models are adopted for different case studies to gain a wide coverage. As is shown, for all those cases tested, the dynamic task scheduling system consistently outperforms the FIFO, PRIQ and T-EDFQ queuing policies, which strongly suggests that the present system's performance gain is insensitive to P(kf)'s

Third, as a solution meant to be used by the current and future DU services in general, the dynamic task scheduling system should be tested against DU services with a wide range of task service time distributions. To this end, Tailbench is utilized to gain access to applications with a wide range of task service time distributions. Tailbench provides eight DU task benchmarks. Each of these workloads allows a sufficiently large number of task service time samples to be collected to construct F(t) for task service time, assuming that the post-queuing time, tₚₒ, is dominated by the task service time, for the lack of the information about the rest of the post-queuing delays. It is further assumed that Fₗ(t)=F(t) for l=1, . . . , N, i.e., the homogeneous case, which do not change over time (all the other delays and heterogeneity will be accounted fully in the SaS case study). These workloads can be classified into three groups with distinct characteristics for F(t). One workload is selected from each group to be tested, including Masstree for in-memory key-value store, Shore for SSD-based transactional database and Xapian for web search.

Table 2 below shows the mean task service time Tₘ (ms) and the unloaded 99^{th} percentile query tail latency

$${x}_{99}^{u} ( ms )$$

will various fanouts.

TABLE 2

| Bench | Tₘ | ${x}_{99}^{u} ( 1 )$ | ${x}_{99}^{u} ( 10 )$ | ${x}_{99}^{u} ( 100 )$ |
|---|---|---|---|---|
| Masstree | 0.176 | 0.219 | 0.247 | 0.473 |
| Shore | 0.341 | 2.095 | 2.721 | 2.829 |
| Xapian | 0.925 | 2.590 | 2.998 | 3.308 |

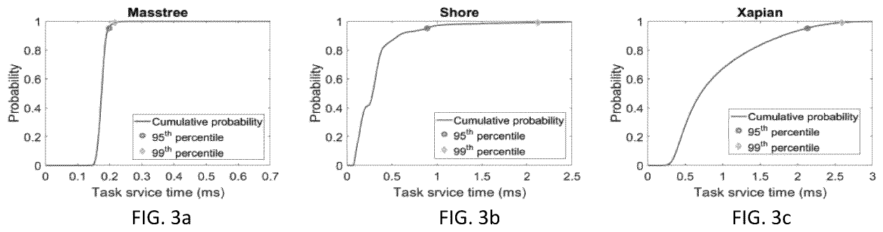

FIG. 3 depicts the CDFs and the unloaded 95/99th percentile task tail latencies for the three workloads. Table 2 also gives the related statistics, including the mean task service time (Tₘ) and the unloaded 99th percentile query tail latency at fanouts k_{f}=1, 10, and 100, derived from Eqns. (1) and (2).

Impact of query fanout. Here the focus is on testing the impact of the query fanout. Two cases are presented, i.e., a single class case and a two-class case. Consider a cluster of size N=100 and three different types of queries corresponding to three different fanouts 1, 10 and 100, similar to a testing scenario in which fanouts 1, 8 and 33 are used. Further assume P(1)=100/111, P(10)=10/111, and P(100)=1/111, i.e., the probability for a fanout is inversely proportional to the fanout itself, similar to the one observed by Facebook. This makes the total numbers of tasks from the three query types to be, on average, the same. For a given tail latency SLO of

$${x}_{99}^{SLO} ,$$

the task pre-dequeuing time budget for a query with fanout k_{f} (1, 10, or 100) is

$${T}_{b} = {x}_{99}^{SLO} - {x}_{99}^{u} ( {k}_{f} ) .$$

Note that meeting the tail latency SLO for queries as a whole does not guarantee that queries of individual types can meet the tail latency SLO. Hence, in the following simulation, the tail latency is measured for each type of queries and identify the maximum load at which all three types of queries meet their tail latency SLOs

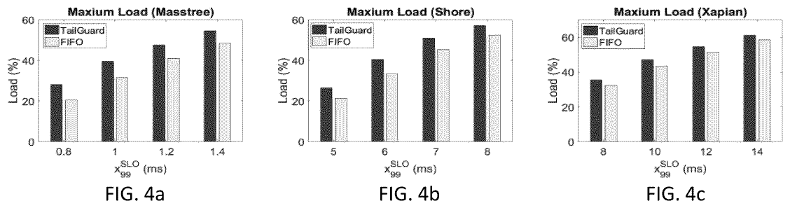

First the case with a single service class is considered, i.e., all the queries have to meet a single SLO. In this case, both PRIQ and T-EDFQ behave exactly the same as FIFO and hence, the dynamic task scheduling system is only compared against FIFO. FIG. 4 depicts the maximum loads that can meet the tail latency SLO for the dynamic task scheduling system and FIFO for four different tail latency SLOs (these SLOs are chosen such that the corresponding maximum loads fall in the range of 20% to 60% which are the typical system loads for the current commercial clouds serving DU applications). This gives the dynamic task scheduling system's performance gain/loss with respect to those of the currently practiced ones. As can be seen, for all the cases, the dynamic task scheduling system achieves higher loads compared to FIFO, while meeting the same tail latency SLO. The performance gain increases as the tail latency SLO becomes tighter. This is because a query with a higher fanout has a tighter task queuing deadline and hence, higher chance to violate the tail latency SLO. Therefore, the dynamic task scheduling system that reorders the tasks based on queuing deadlines can help meet the tail latency SLO for all queries, resulting in higher performance than FIFO, especially when the tail latency SLO becomes more stringent. For example, for Masstree, the maximum load increases from 20% for FIFO to 28% for the dynamic task scheduling system at x₉₉^{SLO}=0.8 ms resulting in about 40% higher resource utilization. In other words, the dynamic task scheduling system can save 40% task server resources over FIFO (also PRIQ and T-EDFQ), while meeting the same tail latency SLO, hence reducing the cost. Accordingly, this test data shows the improvement in the technology over other computing systems and methods. At least in one aspect, the improvement in the computing technology is shown by the savings in server resources during the handling of a query and/or response.

To gain more insights, for Masstree, Table 3 gives the breakdowns of the tail latencies at the maximum loads for the three types of queries. First, it is noted that at the maximum loads, the query type with k=100 barely meets the tail latency SLOs for both schemes. In other words, the maximum achievable load for both queuing policies are constrained by the query type with the highest k_{f}. For the other two query types, the tail latencies are smaller than the corresponding tail latency SLOs, implying that they get more resources than they need, especially for the one with k_{f}=1. The performance gain for the dynamic task scheduling system comes from more balanced resource allocation among the three types, as evidenced by the closer tail latencies among the three types than those for FIFO. The results clearly indicate that the query fanout has to be taken into consideration in task resource allocation for meeting query tail latency SLO to maximize the system performance. Table 3 shows the 99th tail latency (ms) of the three types of queries at maximum loads for the mastertree workload.

TABLE 3

| | | K_{f} = 1 | K_{f} = 10 | K_{f} = 100 |
|---|---|---|---|---|
| x₉₉ = 0.8 | FIFO | 0.439 | 0.594 | 0.798 |
| | TailGuard | 0.572 | 0.745 | 0.797 |
| x₉₉ = 1.0 | FIFO | 0.533 | 0.731 | 0.997 |
| | TailGuard | 0.705 | 0.941 | 0.994 |
| x₉₉ = 1.2 | FIFO | 0.647 | 0.889 | 1.192 |
| | TailGuard | 0.817 | 1.098 | 1.193 |
| x₉₉ = 1.4 | FIFO | 0.751 | 1.061 | 1.389 |
| | TailGuard | 0.945 | 1.262 | 1.392 |

Now the case with two service classes is considered, with the tail latency SLO of the lower class being 1.5 times of that of the higher class, i.e., 1.5x₉₉, where x₉₉ is the tail latency SLO for the higher class. Each query is randomly assigned to one of the two classes with equal probability. Both the Poisson and Pareto arrival processes are considered. Due to limited space, only the results for the Masstree workload are given (the results for the other two workloads are similar).

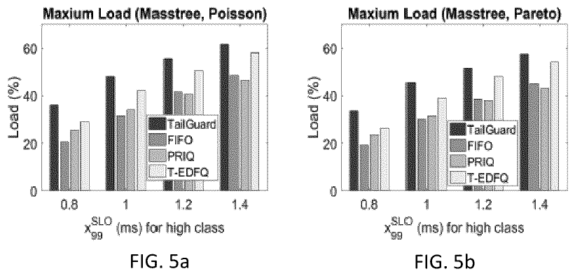

FIG. 5 shows the maximum loads under which all queries can meet their tail latency SLOs. From the results (FIG. 5a) with the Poisson arrival process, it can be seen that the performance gains of TailGuard over FIFO increase to up to 80%, much higher than that in the single class case (i.e., up to 40%). FIFO treats every task equally. Hence its performance is constrained by the most resource demanding queries, i.e., the higher class queries with the largest fanout. The dynamic task scheduling system performance gain is up to 40% with respect to PRIQ. PRIQ gives higher priority to the higher class queries, resulting in lower class queries having less resources to meet their tail latency SLOs. The dynamic task scheduling system performance gain is up to about 22% with respect to T-EDFQ, smaller than that with respect to PRIQ. This means that by incorporating the actual tail latency SLO, rather than just the class information, T-EDFQ can allocate task resources more accurately than PRIQ does. In turn, dynamic task scheduling system improves over T-EDFQ by further incorporating query fanout information in task resource allocation.

The performance gains for TailGuard against the other three schemes with the Pareto arrival process (FIG. 5b) are similar to those with the Poisson arrival process. Meanwhile, the maximum loads decease about 2% to 6% for all schemes compared to those with the Poisson arrival process. This means that the burstiness of query arrivals mainly impact the overall achievable load, but much less on the relative performance of different queuing policies. Hence, in the following cases studies, only those with the Poisson arrival process are presented.

Impact of service class. Again, consider the cluster of size N=100. Now all queries have the same fanout of k_{f}=100, i.e., for each query, its tasks are served by all the task servers in the cluster in parallel, which is the case for OLDI services. The performance of the dynamic task scheduling system is evaluated for workloads with two different service classes, denoted as Classes I and II. The tail latency SLOs for Class I/II are 1/1.5, 6/10 and 10/15 ms for Masstree, Shore and Xapian, respectively. Again, these tail latency SLOs are chosen such that the achievable maximum load ranges from 20% to 60%. A query has equal probability to request for either of the two classes. For any query of a given class, by substituting the corresponding

$${x}_{99}^{SLO} and {x}_{99}^{u} ( 100 )$$

from Table 2 into Eq. (6), the task pre-dequeuing time budgets are arrived at. For example, for Masstree, the budgets for classes I and II are 1-0.473=0.527 ms and 1.5-0.473=1.027 ms, respectively. As the fanout is the same for all queries, T-EDFQ behaves the same as the dynamic task scheduling system, and hence the performance is compared against both FIFO and PRIQ.

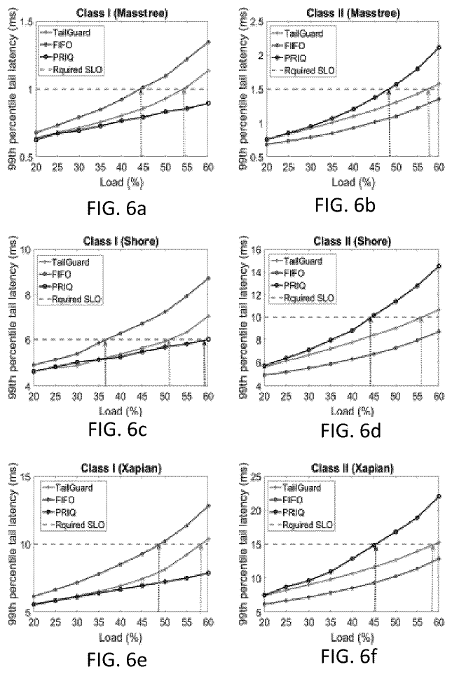

FIG. 6 shows the simulation results. For each plot, the cyan dash line represents the tail latency SLO for that class and the arrows, each having the same color as the tail latency curve for a queuing policy, indicate the maximum achievable loads that meet the tail latency SLOs.

As one can see, for all three workloads, FIFO, which is class unaware, gives equal resources to queries from both classes. Since the task resource demands or task pre-dequeuing time budgets for tasks from classes I and II are quite different, e.g., 0.527 ms and 1.027 ms, respectively, as calculated above, for Masstree, indiscriminately allocating equal resources to tasks results in a very low achievable load for class I queries but very high achievable load for class II queries, e.g., 45% for class I, as shown in FIG. 6a, and higher than 60% for class II, as shown in FIG. 6b. Consequently, to meet the tail latency SLOs for both classes, FIFO allows the cluster to run at 45% for Masstree, 36% for Shore (see FIG. 6c) and 49% for Xapian (see FIG. 6e).

PRIQ, on the other hand, is class aware, but it gives strict priority to tasks in Class I over Class II. This results in unbalanced resource allocation in favor of Class I over Class II. Consequently, the maximum load for class II is about 48% for Masstree, and about 45% for both Shore and Xapian, while the maximum load for class I reaches more than 60% for all three workloads. Again, the low load for class II limits the overall achievable load that meets both tail latency SLOs.

In contrast, as a class-aware approach and with task budgeting, the dynamic task scheduling system can balance the resources allocated to tasks closely in proportion to their resource demands, resulting in much closer maximum loads for the two classes (i.e., within 5% difference) for all three workloads. As shown in FIG. 6, the maximum loads for Classes I and II for Masstree/Shore/Xapian are about 54%/51%/58% and 57%/56%/59%, respectively. Hence, the maximum loads that meet both tail latency SLOs are 54%/51%/58% for the three workloads, respectively. The performance gain of the dynamic task scheduling system over FIFO and PRIQ are up to 40% (i.e, from 36% to 51%) compared to FIFO and up to 30% (i.e., from 45% to 58%) compared to PRIQ.

Dynamic task scheduling with query admission control. Now the dynamic task scheduling system query admission control scheme is tested. Consider the same case presented with respect to impact of service class (only the result of Masstree is given due to limited space). The dynamic task scheduling system is first run without admission control to find the task queuing deadline violation threshold Rth at the maximum acceptable load when the dynamic task scheduling system can barely provide the tail latency SLO guarantee. The maximum acceptable load thus found is about 54% and the corresponding threshold is 1.7%. A moving window is used with size of 1000 queries (or 100000 tasks) to compute the task queuing deadline violation ratio.

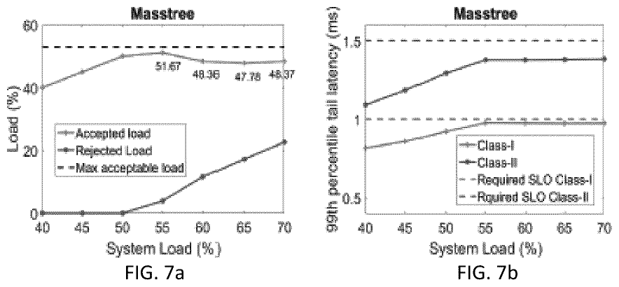

FIG. 7 shows the accepted/rejected loads and the query tail latencies at different loads. First, it is seen that the query tail latency SLOs for both classes are guaranteed at all loads. When the load is over the maximum acceptable loads, the query tail latency of Class I closely approaches its tail latency SLO, while the tail latency of Class II is a little below its SLO. This is due to the fact that Class I tasks have tighter pre-dequeuing time budgets to meet and hence have higher chances to miss the queuing deadlines as explained above. Second, it is noted that the accepted loads (the load may be computed using the accepted queries only) closely approach its respective maximum acceptable loads (within 2.5%). Further increasing the load beyond the maximum acceptable loads, the accepted load drops to about 6% below the maximum acceptable loads. There are two reasons for this to happen. First, the dynamic test scheduling system may not drop the exact number of queries needed to perfectly meet the tail latency SLO. Second, just like any feedback loop control solutions, the dynamic task scheduling system incurs a delay between the measurement and control, which inevitably makes the achievable load to be lower than the maximum acceptable load. Nevertheless, these results demonstrate that the dynamic task scheduling system query admission control can indeed provide tail latency SLO guarantee, while maintaining high resource utilization.

Evaluation in an Sas Testbed. Here, the dynamic task scheduling system is evaluated and compared against the other three schemes in an on-campus Sas testbed.

Testbed Setup. The testbed is currently composed of four clusters of edge nodes, located in four rooms in two buildings, including a server room and a Graduate Research Assistant (GRA) office next to a wet lab in one building, and a faculty office and a Graduate Teaching Assistant (GTA) office in another building. Each of these four clusters, referred to as Server-room, Wet-lab, Faculty and GTA clusters hereafter, consists of 8 Raspberry Pi devices, serving as edge nodes, with each currently attached with a temperature sensor and humidity sensor and connected to the Internet through an Ethernet switch. Each edge node receives sensing data from both sensors periodically and keeps up to eighteen-month-worth of the data records. Since the Wet-lab cluster may require low delay sensing data, the higher performing Raspberry Pi's are used to furnish the cluster than the ones for the other three and have the query handler co-located with the cluster to minimize the communication delay,

Use cases. Three likely use cases are considered belonging to three distinct classes, A, B, and C, to stress test the dynamic task scheduling system, with the 99th percentile tail latency SLOs equal to 800, 1300, and 1800 ms, respectively.

First, it is noted that the server room and wet lab are shared by many research groups and individuals, who may want to closely monitor individual devices they own to track the sensing data. This use case can stress test the dynamic task scheduling system by generating heavier workload on these two clusters than the other two. To create even more unbalanced load, instead of evenly distributing the load on these two clusters, 80% of such workload is placed on the Server-room cluster and the rest 20% randomly assigned to the others. Moreover, queries of this use case are considered class A with the most stringent tail latency SLO and constitute 50% of the total queries. Second, a use case is considered targeting potential users who may want to get an overall reading of the temperature and humidity in all areas with low delay. For such use case, a query fans out 4 tasks, each accessing a randomly selected edge node in a separate cluster. This use case is considered less time critical than the previous one and thus designated class B. It is assumed that it takes up 40% of the total queries.

Third, some users may require detailed, relatively longer term sensing data records to be retrieved from all edge nodes with a loose tail latency SLO. Hence, all the queries in this use case have fanout 32 and are assigned as class C, and 10% of the total queries are assigned to this class.

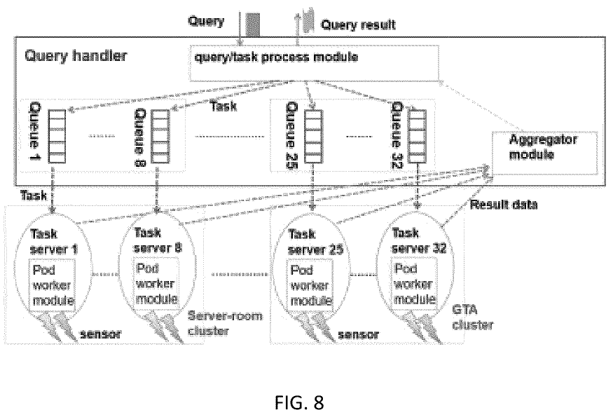

SaS testbed architecture. FIG. 8 depicts the SaS testbed architecture. The query handler runs in a PC and consists of a query/task process module and an aggregator module. Queuing takes place centrally in the query/task process module with 32 sets of queuing buffers allocated, one for each edge node. The testbed resources are managed by K3s [49], which orchestrates the pod resource allocation in edge nodes. All the communications between the query handler and an edge node use keep-alive HTTP/1.1 connections.

A task at an edge node retrieves one or multiple temperature and/or humidity records from the local database. It has an equal probability of retrieving one to up to thirty-day-worth of consecutive records starting from a random time in the eighteen-month period. After retrieving the records, the edge node sends the records to the aggregator module and an edge-node-idle message to the process module. Upon receiving the records for all the query tasks, the aggregator merges the records for the query, which are finally sent to the user.

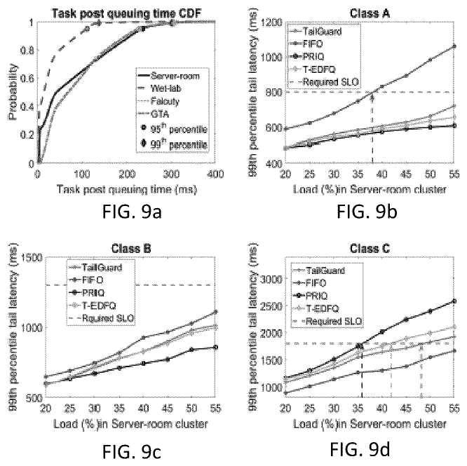

To further test if the dynamic task scheduling system can perform well with inaccurate CDFs of unloaded task post-queuing times, all 8 edge nodes in each cluster are allowed share the same CDF based on the samples evenly collected from all edge nodes in the cluster. FIG. 9a presents the CDFs for all four clusters. First, it is noted that the CDFs for Faculty and GTA clusters are almost identical, as they use the same model of Raspberry Pi's and located in the same building. With the same model of Raspberry Pi's but located in a different building and closer to the query handler, the CDF for the Sever-room cluster concentrates more in the lower post-queuing time region than the previous two. In contrast, equipped with the highest performing Raspberry Pi's and co-located with the query handler, the Wet-lab cluster offers significantly smaller overall post-queuing time than the other three. More specifically, the mean, 95th, and 99th task post queuing times are about 82/31/92/91 ms, 235/112/226/228 ms, and 300/136/306/304 ms for the Server-room/Wet-lab/Faculty/GTA clusters, respectively, making the system heterogeneous. With class A queries highly concentrated on the Server-room cluster, a highly heterogeneous scenario is created where the Server-room cluster is the most heavily loaded, whereas the Wet-lab cluster is highly under-utilized. This is an ideal scenario to stress test dynamic task scheduling system. The reason is that a query from any class that has a task using the Server-room cluster has a higher probability to be the slowest one and hence a high chance to determine the query response time. In this case, the query fanout impact on the query performance is much reduced, making dynamic task scheduling system less effective with respective to the other three queuing policies, which are fanout agnostic.

Results and Analysis. FIGS. 9b, 9c, and 9d show the testing results. It is noted that the dynamic task scheduling system, FIFO, PRIQ and T-EDFQ can achieve the maximum load of about 48%, 38%, 36% and 42%, respectively. This results in the performance gains of the dynamic task scheduling system over FIFO, PRIQ and T-EDFQ to be 26.3%, 33.3% and 14.3%, respectively. As one can see, both the performance gains and the maximum load differences in such a highly heterogeneous system are in line with the simulated ones (homogeneous systems).

The above stress test, together with the simulation, demonstrates that the dynamic task scheduling system is effective to improve resource allocation performance for DU applications, even in a heterogeneous system with highly unbalanced workload patterns, and varied processing and communication delays. As the testbed grows larger, one can expect that the performance gains of the dynamic task scheduling system over the other three fanout-agnostic schemes will further increase because the average query fanout is likely to increase with the number of edge nodes in the testbed.

The features and other aspects and principles of the disclosed embodiments may be implemented in various environments. Such environments and related applications may be specifically constructed for performing the various processes and operations of the disclosed embodiments or they may include a general-purpose computer or computing platform selectively activated or reconfigured by program code to provide the necessary functionality. Further, the processes disclosed herein may be implemented by a suitable combination of hardware, software, and/or firmware. For example, the disclosed embodiments may implement general purpose machines configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general purpose machines as computer processing instructions, all or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low-level software instructions, such as machine code (e.g., such as that produced by a compiler) and/or high-level code that can be executed by a processor using an interpreter.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology described above with reference to user devices may include mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smart phones.

In this description, numerous specific details have been set forth. It is to be understood, however, that implementations of the disclosed technology may be practiced without these specific details. In other instances, well-known methods, structures, and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

It is to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Although embodiments are described herein with respect to systems or methods, it is contemplated that embodiments with identical or substantially similar features may alternatively be implemented as systems, methods and/or non-transitory computer-readable media.

As used herein, unless otherwise specified, the use of the ordinal adjectives “first,” “second,” “third,” etc., to describe a common object, merely indicates that different instances of like objects are being referred to, and is not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A method for processing a data query, the method comprising:
receiving, by a query handler component, a request for a data query to be processed;
generating a plurality of tasks based on the data query;
for each task of the plurality of tasks, determining a task server of a plurality of tasks servers that the task should be dispatched to;
determining a task queuing deadline for the plurality of tasks; and
dispatching each task with the task queuing deadline to a task queue associated with the task server that the task should be dispatched to.

2. The method of claim 1, further comprising determining a pre-dequeuing time budget for the plurality of tasks, wherein the task queuing deadline for the plurality of tasks is based at least in part on the determined pre-dequeuing time budget.

3. The method of claim 1, further comprising determining a query tail latency for the plurality of servers, wherein the task queuing deadline for the plurality of tasks is based at least in part on the determined query tail latency.

4. The method of claim 1, wherein each task is inserted into its corresponding task queue based on its associated task queuing deadline.

5. The method of claim 1, further comprising determining an estimate of a task post-queuing time distribution for each task server of the plurality of task servers, and providing the task post-queuing time distributions to the query handler component.

6. The method of claim 5, further comprising updating the task post-queuing time distribution for each task server of the plurality of task servers, and providing the updated task post-queuing time distributions to the query handler component.

7. The method of claim 1, further comprising processing each task by a respective task server and returning a task result for each task to the query handler.

8. The method of claim 7, further comprising merging the task results to generate a query result.

9. The method of claim 1, further comprising setting a task deadline violation ratio and rejecting one or more requests if the ratio is exceeded.

10. The method of claim 1, wherein each task queue is located at the query handler component or at the task server.

11. A system comprising:
one or more processors; and
a non-transitory memory in communication with the one or more processors, and storing instructions thereon, that when executed by the one or more processors, are configured to cause the system to:
receive, from a user device, a request for a data query to be processed;
decompose the data query into a plurality of tasks for completing the data query, each task of the plurality of tasks to be processed by a respective one of a plurality of task servers;
for each task server, estimate a task queuing time budget for processing a respective task based on a typical task sever workload;
transmit instructions for completing a respective task to a respective one of the plurality of task servers for each task of the plurality of tasks;
receive, from each task server, a task result comprising a response to the respective task;
responsive to receiving each task result associated with processing the data query, merge each of the task results to generate a query result; and
transmit the query result to the user device.

12. The system of claim 1, wherein the non-transitory memory comprises additional instructions, that when executed by the one or more processors, are configured to cause the system to, for each task server, intermittently update the task queuing time budget for subsequent tasks to be processed based on a queuing time of a task previously processed by the respective task server.

13. The system of claim 1, wherein the data query comprises a first data query and a second data query and wherein the non-transitory memory comprises additional instructions, that when executed by the one or more processors, are configured to cause the system to:
determine a query queuing budget measure for each of the first data query and the second data query based on a number of task servers required to process each task associated with the first data query and second data query, and a predetermined tail latency requirement of the first data query and second data query respectively; and
determine which of the first query and the second query to process first based on the determined query queuing budget measures.

14. The system of claim 3, wherein the non-transitory memory comprises additional instructions, that when executed by the one or more processors, are configured to cause the system to:
assign a task queuing latency threshold to the request; and
responsive to a threshold number of tasks of the plurality of tasks exceeding the task queuing latency threshold, reject queuing of subsequent data queries until the task latency threshold is no longer exceeded.

15. The system of claim 1, wherein the user device comprises a front-end server.

16. A computer-implemented method for processing a data query, the method comprising:
receiving, from a user device, a request for a data query to be processed;
decomposing the data query into a plurality of tasks for completing the data query, each task of the plurality of tasks to be processed by a respective one of a plurality of task servers;
for each task server, estimating a task queuing time budget for processing a respective task based on a typical task sever workload;
transmitting instructions for completing a respective task to a respective one of the plurality of task servers for each task of the plurality of tasks;
receiving, from each task server, a task result comprising a response to the respective task;
responsive to receiving each task result associated with processing the data query, merging each of the task results to generate a query result; and
transmitting the query result to the user device.

17. The method of claim 6, further comprising: for each task server, intermittently updating the task queuing time budget for subsequent tasks to be processed based on a queuing time of a task previously processed by the respective task server.

18. The method of claim 6, wherein the data query comprises a first data query and a second data query and wherein the method further comprises:
determining a query queuing budget measure for each of the first data query and the second data query based on a number of task servers required to process each task associated with the first data query and second data query, and a predetermined tail latency requirement of the first data query and second data query, respectively; and
determining which of the first query and the second query to process first based on the determined query queuing budget measures.

19. The method of claim 8, further comprising:
assigning a task latency threshold to the request; and
responsive to a threshold number of tasks of the plurality of tasks exceeding the task latency threshold, rejecting the queuing of subsequent data queries until the task latency threshold is no longer exceeded.

20. The method of claim 6, wherein the user device comprises a front-end server.
